(19) United States
(12) Patent Application Publication
(10) Pub. No.: US 2025/0290370 A1
(43) Pub. Date: Sep. 18, 2025

(54) DOOR OPENER FOR AN ELECTRIC HOUSEHOLD APPLIANCE

(71) Applicant: emz-Hanauer GmbH & Co. KGaA, Nabburg (DE)

(72) Inventors: ANDREAS PLACH, Laaber (DE); PHILIPP SCHLAGENHAUFER, Niedermurach (DE)

(21) Appl. No.: 19/064,970

(22) Filed: Feb. 27, 2025

(30) Foreign Application Priority Data
Mar. 15, 2024 (DE) 102024107497.3

(51) Int. Cl. E05F 15/619; A47L 15/42

(52) U.S. Cl. CPC E05F 15/619; A47L 15/4259; E05Y 2201/474; E05Y 2201/652; E05Y 2201/668; E05Y 2201/702; E05Y 2900/304; E05Y 2900/312

(57) ABSTRACT

A door opener for a household appliance, with power transmission decoupling for an electrical household appliance includes an electromotive actuator. A pusher is arranged driveable by means of the actuator in order to push open a door of the household appliance. At least one gear wheel engages in a toothed rack of the pusher to convert a rotary movement into a linear movement of the pusher. The gear wheel is connected to and driven by the actuator by means of a worm gear that can be displaced in the axial direction.

### CROSS-REFERENCE TO RELATED APPLICATIONS

This application claims priority to German Patent Application 102024107497.3, filed on Mar. 15, 2024, the contents of which is incorporated by reference herein.

### TECHNICAL FIELD

The invention relates to a door opener with power transmission decoupling for an electric household appliance.

### BACKGROUND

Door openers for household appliances are known in various embodiments. From US 2019/0150701 A1 for example a door opener for pushing open the door of a dishwasher is known, which has a door opener rod driven by an electric motor via a gear drive, which is formed at a leading end for engagement with a laterally arranged door lock. By pushing forward and pulling back the door opener rod the closed door a gap wide can be pushed open and—provided that the door opener rod is in engagement with the door lock—the door opened a gap wide can be closed again. Longitudinal grooves are formed on the door opener rod, each of which is scanned by a pair of light emitters and photo detectors. The two grooves and the emitter-detector pairs allow different positions of the opener rod to be detected. One of these positions corresponds to a so-called sealed-compressed door position, which is achieved by the user pressing against the door with the door closed, thereby pushing it a little further than the normal closed position. By pressing against the already closed door in this way, the user can signal a request to open the door. When the sealed-compressed position is detected, a dishwasher control activates the electric motor of the door opener to automatically open the door.

Often is it desired, that the hinged door of a dishwasher or of a washing machine is opened at least partially and automatically after completion of a washing process. In a dishwasher for example, this is in order to enable a final drying process after a wash cycle, by opening the door a gap wide, for hot steam to escape from the interior e.g., the tub or the drum. If during such an autonomous opening of the door, the opening process is interrupted by a counteracting resistance force, as it is the case for example, if a person is in front of the door, this opening process shall be cancelled of alone in simple way and in particular without assistance from sensors.

It is also conceivable that such doors of a dishwasher are only ajar during a desired closing operation and then automatically and autonomously complete the closing operation completely, by means of a mechanism which connects the door to the remaining body of the dishwasher. In this case, it is conceivable that such a closing operation should be cancelled automatically if, for example, there are still parts of a hand between the door and the remaining housing of the dishwasher.

Thus, a problem to be solved is to provide a door opener and closer with power transmission decoupling for an electric household appliance, which automatically cancels the process of power transmission during an opening and/or closing process at unintentionally high resistance by means of a simple mechanical construction.

### SUMMARY OF THE INVENTION

According to the invention such a door opener with power transmission decoupling for an electric household appliance comprises the following:
an electromotive actuator;
a pusher arranged drivable by means of the actuator for pushing open a door of the household appliance; and
at least a gear wheel, which engages directly or indirectly in a toothed rack of the pusher, to convert a rotary movement into a linear movement, wherein the gear wheel is connected to and driven by the actuator by means of a worm gear which can be displaced in the axial direction.

With a such assembly it can be made possible, that the worm gear, at occurrence of a high resistance, due to the moving of the actuator further along the gear wheel, is rotated out of engagement with the gear wheel due to the displacement possibility of the worm gear. That is, the worm gear is driven by the actuator further with a constant speed, whereas the gear wheel or gear wheels on the basis of a not moving or only hesitantly moving pusher, which is stopped or slowed down, also come to a standstill. Subsequently, the worm gear disengages with the gear wheel by itself and is thereby positioned before or after the gear wheel by displacement of the worm gear and consequently a longitudinal torsion shaft, the worm gear is arranged on. In this moment no further drive of the pusher in its linear movement takes place, so that automatically the opening movement is stopped.

The displaceable longitudinal torsion shaft of the worm gear extends along a peripheral side of the gear wheel or of a further gear wheel in direction from its gear level and the thereon rotatable arranged worm gear can be positioned before or after the gear wheel in direction of rotation of the gear wheel by displacement of the longitudinal torsion shaft, due to the possible displacement movement. This disengages the worm gear from the gear wheel at an arrangement or positioning of the worm gear before or after the gear wheel, and there is thus a power transmission decoupling between worm gear and gear wheel, which is why thereby the pusher movement is stopped. With an arrangement of the worm gear directly on the gear wheel on the other hand, the worm gear engages with the gear wheel and thus a linear movement of the pusher takes place. It is decisive, that in a normal position of the worm gear, it is engaged with the gear wheel and thus a pusher movement can take place.

Only if the resistance of the pushing-on process is too great, the longitudinal torsion shaft together with the worm gear is displaced with respect to the gear wheel, causing the worm gear to disengage from the gear wheel and a decoupling of power transmission between the driving actuator and the pusher takes place. This results in the linear movement of the pusher being stopped in an automated manner, without the intervention of a person or the evaluation of a sensor signal. This type of design is therefore simple, reliable and thus also cost-effective.

In order to connect the displaceable longitudinal torsion shaft to the actuator in a rotationally locked, i.e. force-transmitting, manner, the longitudinal torsion shaft has at least one cone-shaped or cone-frustum-shaped component at one position, which is connected in a rotationally locked manner to an output shaft or motor shaft or actuator shaft of the actuator by means of at least one belt. In this case, the cone-shaped component is arranged in a stationary manner opposite and on the longitudinal torsion shaft and at least one cylindrical spring element is present on the displaceable longitudinal torsion shaft between this cone-shaped component and a stationary component. This ensures that the displaceable longitudinal torsion shaft is arranged in a fixed position due to the spring force in normal operation, i.e. during an opening process of the pusher. The spring is compressed only when a resistance force occurs, since the displaceable longitudinal torsion shaft is displaced against this spring force due to the worm gear continuing to turn. However, as soon as the resistance has been eliminated and the resistance force is no longer acting, the longitudinal torsion shaft together with the cone-shaped component is pushed back into the initial position by the spring force. Here, the worm gear engages with the teeth of the gear wheel again.

The actuator is advantageously an electric motor with a constant speed of its motor shaft/output shaft.

According to a preferred embodiment, the output shaft is aligned parallel to the longitudinal torsion shaft, which is perpendicular to the gear wheel shafts or centre axes of the gear wheels and perpendicular to a direction of movement of the pusher. This makes it possible to use a connecting belt or belt drive between the actuator's output shaft and the longitudinal torsion shaft aligned parallel to it, in order to drive the longitudinal torsion shaft using the rotational movement of the output shaft. Thus, the cone-shaped component is driven by the belt or a plurality of belts. The cone-shaped component that is thereby rotating in turn drives the longitudinal torsion shaft, which in turn causes the worm gear to rotate. The worm gear engages with the gear wheel as long as the worm gear does not disengage from the gear wheel due to the presence of a resistance force.

The cone-shaped component advantageously has a series of fully circumferential, annular recesses for inserting the belt. This allows different annular recesses with different diameters to be used for the belt to be placed on, in order to obtain different running speeds of the longitudinal torsion shaft and thus of the worm gear, as well as different levels of power transmission. Logically, this also affects the speed of the opening process of the pusher or its linear movement.

The annular recesses can be connected to one another in such a way that they form a spiral running around the entire cone-shaped component. This has the consequence that the pusher experiences different opening speeds depending on its current position, in order to achieve a fast opening speed at the beginning of the movement and a slow opening speed at the end of the movement, for example.

According to a preferred embodiment door opener is arranged in an upper wall element of a dishwasher or a washing machine.

### BRIEF DESCRIPTION OF THE DRAWINGS

Further advantageous embodiment result in connection with of following drawing. It shows:

FIG. 1 in a perspective view, a front and top view of a dishwasher when closed, with a built-in door opener according to the invention;

FIG. 2 in a perspective view, the dishwasher shown in FIG. 1, but with a slightly open door;

FIG. 3 in a top view, the door opener according to one embodiment of the invention;

FIG. 4 in a partial top view, the door opener according to a further embodiment with a worm gear in a first position;

FIG. 5 the partial top view shown in FIG. 4 with a worm gear in a second position;

FIG. 6 in a partial top view, the door opener according to the invention in accordance with a further embodiment of the invention; and

FIG. 7 also in a top view, the embodiment according to FIG. 6, but with a worm gear in a new position.

### DETAILED DESCRIPTION

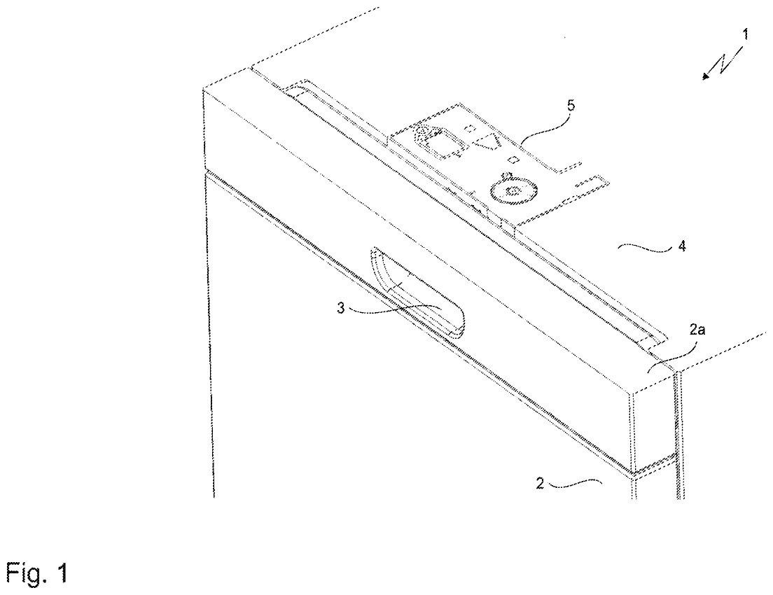

FIG. 1 shows a section of a dishwasher 1 in a perspective front and top view, with a closed door 2. In the upper area 2a of the closed door, there is a non-visible door lock with individual components that are not shown in more detail here and that interact with a door opener 5 during an opening process.

A door handle 3 is provided in the door for opening it. A door opener 5 according to the invention is arranged in the upper area of the dishwasher, i.e. in the upper wall element 4.

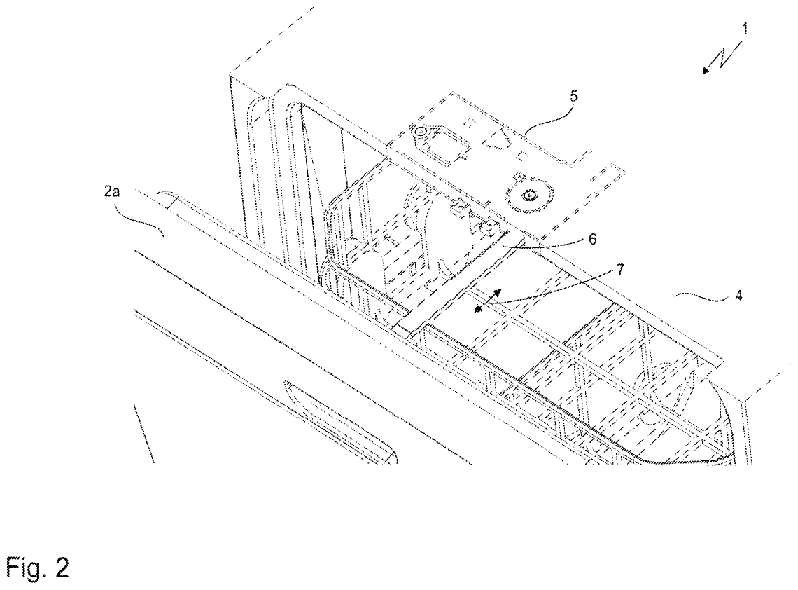

FIG. 2 shows the dishwasher with the door open, as shown in FIG. 1 in perspective. From this illustration, it can be seen that the door opener 5 has extended a pusher 6 that can be moved in the direction of the double arrow 7 in order to slightly open the door after a washing cycle to allow steam to escape. To do this, the pusher 6 pushes the door forward in the upper area 2.

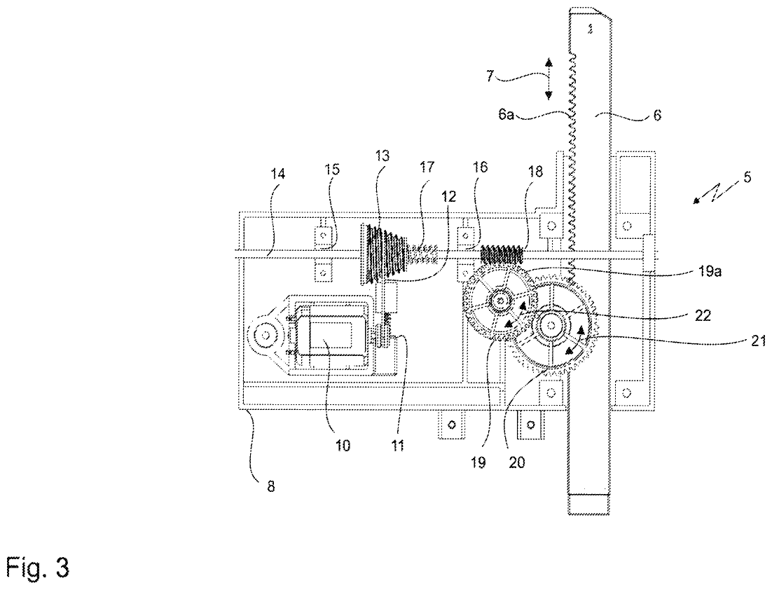

FIG. 3 shows a top view of the door opener according to the invention. It can be clearly seen from this representation that the pusher 6 can be moved forward or backward in a linear motion 7 to push open a door, which is not shown in more detail here, as depicted in FIG. 2. For this purpose, the pusher 6 has a toothed rack 6a that can be driven by means of a gear wheel 20.

An actuator 10, which may be in the form of an electric motor, is arranged in a housing 8 of the door opener. This actuator drives an output shaft 11, which rotates at a constant speed due to the drive by the actuator.

The output shaft 11 is in turn connected via a belt drive 12 to a longitudinal torsion shaft 14, which is rotatably mounted in the bearings 15 and 16 opposite the housing 8.

The belt engages in a channel-like recess of a plurality of recesses within a cone-shaped component 13, which is fixed on the longitudinal torsion shaft 14.

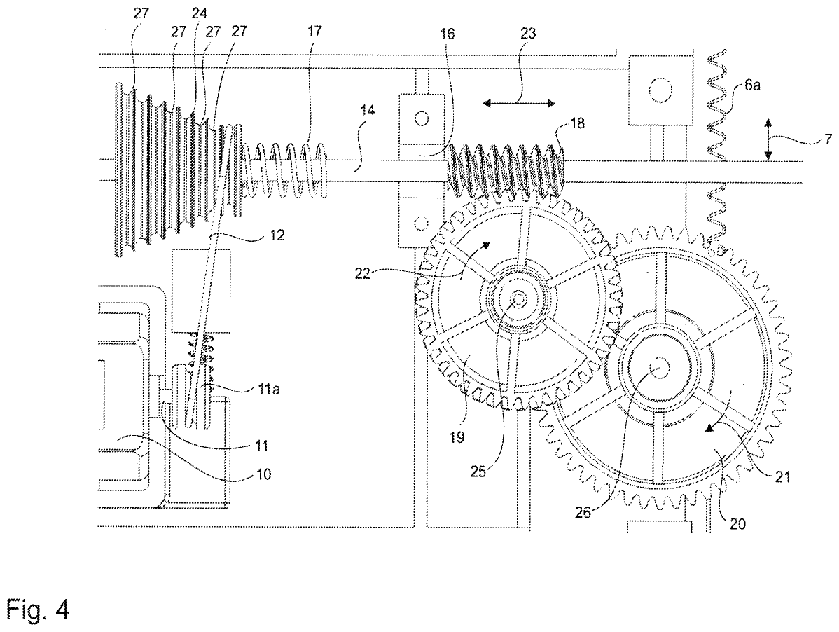

A spiral pressure spring 17 ensures that a distance is maintained between the cone-shaped component 13 and a component 16 that is stationary in relation to the housing 8, thereby keeping a worm gear 18 engaged with the gear wheel 19 in the area of the circumferential edge 19. The longitudinal torsion shaft 14 is displaceable in the longitudinal direction 23, as shown in FIG. 4.

The two gear wheels 19 and 20 are rotatably mounted in accordance with the double arrows 21, 22 and can move in relation to each other in a meshing engagement in such a way that that turning the worm gear 18 moves the toothed rack 6 backwards and forwards via the two gear wheels, whereupon the pusher 6 can push open a door by moving linearly in the direction of the double arrow 7.

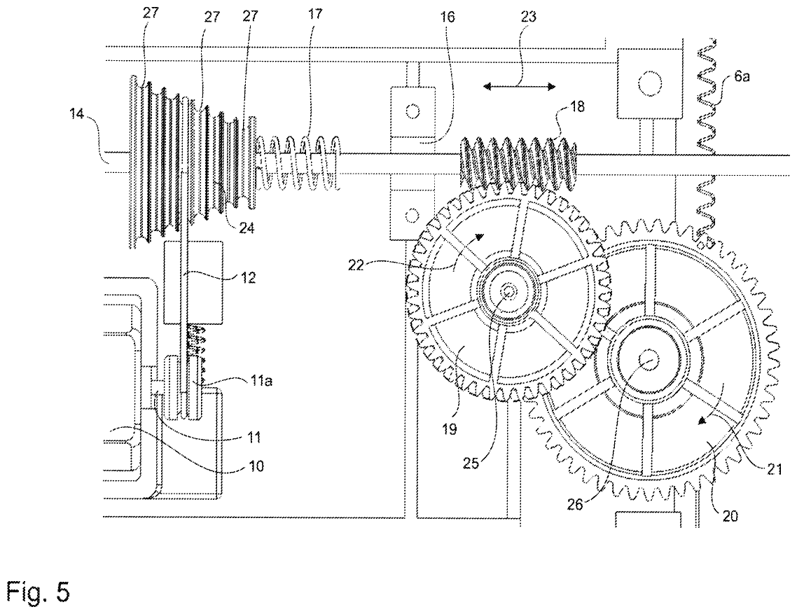

FIG. 4 and FIG. 5 show a section of the door opener according to the invention in a plan view, wherein the two figures differ in that both the belt 12 and the worm gear 18 are arranged at two different positions.

The longitudinal torsion shaft 14 is, as already mentioned, arranged so that it can be displaced in the direction of the double arrow 23, i.e. along its axis. This has the consequence that this shaft 14 can move, even if the belt 12 continues to drive the cone-shaped component 27 at the constant speed of the output shaft and at the same time, however, the toothed rack 6a of the pusher 6 can no longer move because an external force, not described in more detail here, is acting on the pusher 6.

Since the cone-shaped component 27, like the worm gear 18, is firmly connected to the longitudinal torsion shaft 14, both components are moved to the right together with the longitudinal torsion shaft until the worm gear 18 is disengaged from the gear wheel 22 and its teeth, thereby decoupling the power transmission between the worm gear 18 and the gear wheel 22. Then the power is no longer transmitted from the worm gear 18 to the gear wheel and the toothed rack 6a, causing the pusher 6 to no longer move forward.

The gear wheels are arranged so that they can rotate with the two axes 25 and 26, as shown by the arrows 21, 22, which are shown here in the direction of rotation of the gear wheels.

When the actuator 10 is switched on, the output shaft 11 is driven. A roller 11 arranged on the output shaft is also driven and moves a closed belt 12, thereby also driving the cone-shaped component 27. For this purpose, the cone-shaped component has various recesses 27 that are aligned parallel to one another and have different diameters in their course, in order to enable different door opening speeds by arranging the belt 12 accordingly. This is because the speed of rotation of the longitudinal torsion shaft 14 ultimately determines, via the worm gear 18 and the gear wheels 19, 20, the speed of the linear movement 7 of the toothed rack 6a of the pusher and thus of the entire pushing process.

When comparing FIGS. 4 and 5, it becomes clear that by selecting a different recess 27 of the cone-shaped component 24 for the engaging belt 12, a different speed is achieved for the rotational movement of the longitudinal torsion shaft 14, although the actuator 10 has a constant speed.

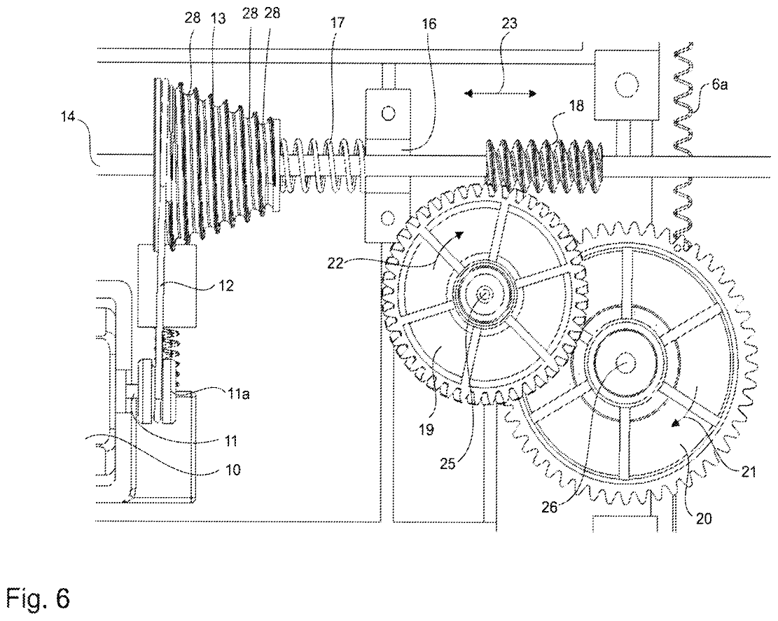

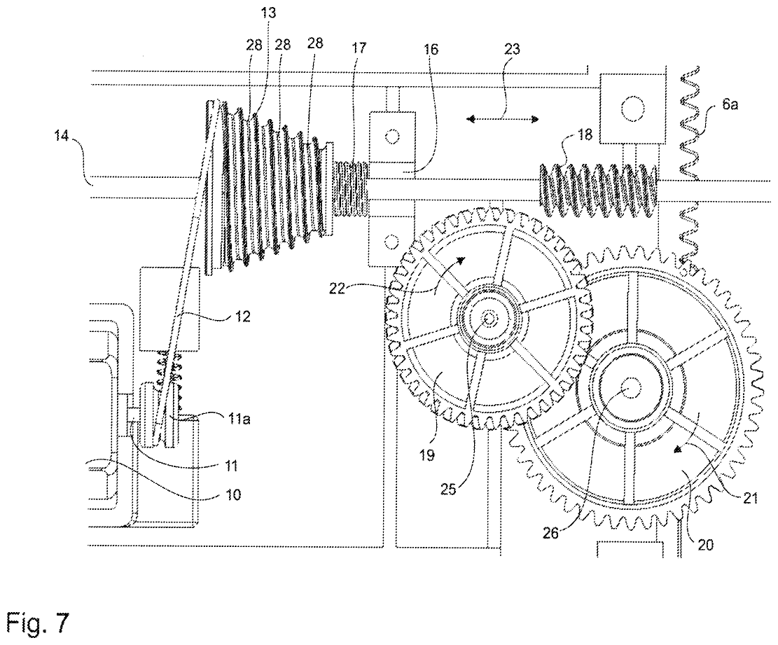

FIGS. 6 and 7 show a further embodiment of the door opener according to the invention in a sectional view and a top view. In this representation, the cone-shaped component 13 is also equipped with individual recesses 28, but these are connected to one another in such a way that they form a spiral overall. Thus, the speed of the moving pusher and the rotating longitudinal torsion shaft 14 can be slowed down by the belt initially engaging with the cone-shaped component 13 on the far right and then being unwound to the left on the cone-shaped component due to the spiral shape of the recesses 28. This results in a slowing down of the rotational movement of the longitudinal torsion shaft 14, since the diameter of the cone-shaped component 13 increases from right to left.

On closer inspection of the illustration shown in FIG. 7, it can be seen that the spiral spring 17 is force- or pressure-loaded, i.e. that the longitudinal torsion shaft 14 is displaced to the right in accordance with the displacement movement 23. This occurs in the situation in which the pusher 6 experiences a resistance force against its direction of movement during the pushing process, whereupon the worm gear 18 continues to be driven by the actuator 10 and the belt 12 but is shifted to the right due to the possible shifting movement of the longitudinal torsion shaft 14 and disengages from the gear wheel 19. The consequence of this is that, in the position of the worm gear 18 shown in FIG. 7, a complete power decoupling has taken place between the worm gear 18 respectively the longitudinal torsion shaft 14 on the one hand and the gear wheels 19, 20 and the pusher 6 on the other. Thus, the pusher 6 is no longer subjected to a force and does not try to push open the dishwasher door against a resistance force that is not described in more detail here.

### LIST OF REFERENCE SYMBOLS

1 Dishwasher
2 Door
2a Top of the door
3 Door handle
4 Upper wall element of the dishwasher
5 Door opener
6 Pusher
7 Pusher direction of movement
8 Door opener housing
10 Actuator
11 Output shaft
11a Roller
12 Belt
13 Cone-shaped component
14 Longitudinal torsion shaft
15 Bearing
16 Bearing/stationary component
17 Spiral spring
18 Worm gear
19 Gear wheel
20 Gear wheel
21 Direction of rotation
22 Direction of rotation
19a Peripheral side
23 Longitudinal displacements
24 Cone-shaped component
25 Axis
26 Axis
27 Recesses
28 Recesses

1. Door opener (5) with power transmission decoupling for an electric household appliance (1), comprising
an electromotive actuator (10),
a pusher (6) arranged drivable by means of the actuator (10) for pushing open a door (2) of the household appliance (1),
at least one gear wheel (20) which engages in a toothed rack (6a) of the pusher (6) in order to convert a rotary movement (21) into a linear movement (7) of the pusher (6),
wherein
the gear wheel (20) is connected to and driven by the actuator (10) by means of a worm gear (18) that can be displaced in the axial direction (23).

2. Door opener according to claim 1,
wherein
a displaceable longitudinal torsion shaft (14) of the worm gear (18) extends along a peripheral side (19a) of the gear wheel (20) or of a further gear wheel (19) in the direction (23) of the gear wheel plane and the rotatable worm gear (18) arranged thereon, can be positioned in front of, on or after the gear wheel (19, 20), viewed in the direction of rotation (21; 22) of the gear wheel (19; 20), by displacing the longitudinal torsion shaft (14).

3. Door opener according to claim 1,
wherein
at least one cone-shaped component (13, 24) is arranged on the displaceable longitudinal torsion shaft (14), which is connected in a rotationally locked manner to an output shaft (11) of the actuator (10) by means of at least one belt (12).

4. Door opener according to claim 3,
wherein
the cone-shaped component (13; 24) is arranged in a stationary manner on the longitudinal torsion shaft (14) and at least one cylindrical spring element (17) is arranged on the displaceable longitudinal torsion shaft (14) between the cone-shaped component (13, 24) and a component (16) arranged in a stationary manner.

5. A door opener according to claim 3,
wherein
the actuator is an electric motor (10) with a constant speed of the output shaft (11).

6. A door opener according to claim 3,
wherein
the output shaft (11) is aligned parallel to the longitudinal torsion shaft (14) and the latter is aligned perpendicular to the gear wheel shafts (25, 26) of the gear wheels (19, 20) and perpendicular to a direction of movement (7) of the pusher (6).

7. Door opener according to claim 3,
wherein
the cone-shaped component (13, 24) has fully circumferential annular recesses (27, 28) that are intended for the belt (12) to be inserted in, which are arranged one behind the other.

8. Door opener according to claim 7,
wherein
the annular recesses (27, 28) have different diameters.

9. Door opener according to claim 7,
wherein
the annular recesses (28) are connected to one another in such a way that they form in their entirety a spiral running around the cone-shaped component (13).

10. Door opener according to claim 1,
wherein
the door opener (5) is arranged in an upper wall element (4) of a dishwasher (1) or a washing machine.
